(19) United States
(12) Patent Application Publication
(10) Pub. No.: US 2011/0184112 A1
(43) Pub. Date: Jul. 28, 2011

(54) SILICONE RUBBER COMPOSITIONS

(76) Inventors: Catherine Dickins, Mid Glamorgan (GB); Phillip Joseph Griffith, Midland, MI (US); Michael Protor, Llanmaes (GB); Rosemary Margaret Taylor, South Glamorgan (GB)

(21) Appl. No.: 12/992,408

(22) PCT Filed: May 14, 2009
(86) PCT No.: PCT/US09/02986

§ 371 Date: Mar. 23, 2011

(30) Foreign Application Priority Data
May 14, 2008 (GB) GB0808678.6

(51) Int. Cl. C08K 3/22

(52) U.S. Cl. 524/430

(57) ABSTRACT

There is provided a silicone rubber composition comprising an organopolysiloxane having a viscosity of at least 250,000 mPa·s at 250C, treated filler, and an organic peroxide curing agent. The composition is substantially free of reinforcing silica fillers and is characterised in that the filler comprises a mixture of aluminium trihydroxide and kaolin in a ratio of from 1:3 to 4:1.

This invention is related to highly filled silicone rubber compositions containing a mixture of kaolin and aluminium trihydroxide fillers. In particular, it relates to the use of kaolin and aluminium trihydroxide as substantially the only fillers in the silicone rubber composition.

Silicone rubbers, often referred to as silicone elastomers, are composed of three essential ingredients. These ingredients are (i) a substantially linear high molecular weight silicone polymer, (ii) one or more filler(s), and (iii) a curing agent, sometimes referred to as a crosslinking agent or a vulcanising agent. Generally, there exist two main types of silicone rubber compositions heat vulcanised, (HTV) silicone rubber and room temperature vulcanising (RTV) silicone rubber. Heat vulcanised or high temperature vulcanising (HTV) silicone rubber compositions are often further differentiated as high consistency rubber (HCR) or liquid silicone rubber (LSR) depending on uncured viscosity of the composition.

The name room temperature vulcanising (RTV) silicone rubber compositions, however may be misleading as many RTV compositions require a modicum of heat to progress the reaction at a reasonable rate.

HTV silicone rubber compositions are typically prepared by mixing the substantially linear high molecular weight silicone polymer with the filler and other desired additives to form a base or raw stock. Prior to use, the base is compounded to incorporate the curing agent, other fillers, and additives such as pigments, anti-adhesive agents, plasticizers, and adhesion promoters; and it can be vulcanised by press vulcanisation, injection or transfer moulding or continuously by extrusion, to form the final silicone rubber product. For example silicone rubber compositions used for cable insulation applications are extruded by special techniques in which the silicone rubber is applied to cable cores by means of angular extruder heads.

For high consistency rubber (HCR) the substantially linear high molecular weight silicone polymer most widely employed is a very high viscosity polysiloxane. Such linear high molecular weight silicone polymers have a viscosity of 1,000,000 mPa·s or more at 25° C. Typically these linear high molecular weight silicone polymers have such high viscosities at 25° C. that they are in the form of gum like materials which have such high viscosities that the measurement of viscosity is extremely difficult and therefore they are often referred by reference to their Williams plasticity number (ASTM D926). The Williams plasticity number of high viscosity polysiloxane gum-like polymers are generally at least 30, typically they are in the range of from about 30 to 250. The plasticity number, as used herein, is defined as the thickness in millimeters×100 of a cylindrical test specimen 2 cubic cm in volume and approximately 10 mm in height after the specimen has been subjected to a compressive load of 49 Newtons for three minutes at 25° C. These polysiloxane gum-like polymers generally contain a substantially siloxane backbone (—Si—O—) to which are linked alkyl groups such as for example methyl, ethyl, propyl, isopropyl and t-butyl groups, and unsaturated groups for example alkenyl groups such as allyl, 1-propenyl, isopropenyl, or hexenyl groups but vinyl groups are particularly preferred and/or combinations of vinyl groups and hydroxyl groups to assist in their crosslinking. Such polysiloxane gum-like polymers typically have a degree of polymerisation (DP) of 500-20,000, which represents the number of repeating units in the polymer.

Historically HTV silicone rubber compositions contain one or more fillers. The fillers used are usually referred to as reinforcing fillers and non-reinforcing fillers. Reinforcing fillers impart high strength to vulcanised rubber and may comprise finely divided amorphous silica such as fumed silica and precipitated silica. Extending or non-reinforcing fillers are generally used to reduce the cost of the silicone rubber composition, and generally comprise inexpensive filler materials such as ground quartz, calcium carbonate, and diatomaceous earth. Reinforcing fillers are typically used alone or together with extending or non-reinforcing fillers. The reinforcing fillers are usually treated with organosilanes, organosiloxanes, or organosilazanes, in order to improve the physical and/or mechanical properties of the silicone rubber composition, i.e., tensile strength and compression set.

Compositions made by blending aluminum trihydroxide powder into silicone rubber compositions are generally known. It is also known that silicone rubber moldings with excellent electrical properties are obtained by the cure of silicone rubber compositions that contain large amounts of aluminum trihydroxide powder as described in JP 05-12805 and JP 07-57574. However, these silicone rubber compositions contain large amounts of aluminum trihydroxide powder, which is strongly water absorptive, and results in poor water resistance. These compositions will also absorb moisture with the passage of time, leading to a decline in their electrical insulating properties. Hence, they are not fully acceptable as an Electrical insulation silicone rubber composition for high-voltage use. Furthermore, these silicone rubber compositions are not suitable for use in some applications due to their poor mechanical strength, such as tensile and tear strengths.

EP0787772 provides a silicone rubber composition that has excellent electrical properties, and while lacking a reinforcing filler, adequate mechanical strengths. Such a composition is obtained by the incorporation into of an aluminum trihydroxide powder which has been treated with an agent selected from silanes or siloxanes having alkenyl, and alkoxy or hydroxy substitution thereon.

EP0808868 describes a silicone rubber composition for use as electrical insulation that cures into a highly water-resistant silicone rubber. It comprises (A) polyorganosiloxane, (B) aluminum trihydroxide powder surface treated with an organosilane or organosilazane, and (C) curing agent. The composition is enhanced by the optional addition of 1 to 200 weight parts of (D) a silica filler to the composition formed by combination of components (A) to (C).

U.S. Pat. No. 4,677,141 describes a means of improving the heat stability of a pigmentable silicone elastomer comprising a vinyl terminated organopolysiloxane polymer, a silica based reinforcing filler and an organic peroxide curing agent with a white clay such as kaolin which has been pre-treated with olefinic unsaturated siloxy groups. EP0057084 relates to a similar technology but again requires the presence of a reinforcing filler, in the form of silica.

The use of kaolin as a filler in silicone rubber compositions in the absence of silica is known and described several patent applications, such as, for example, WO2006/134400, WO2005/054352, WO2005/092965, WO2006/091241 WO 2008/045395 and WO2006/041929. The physical characteristics of cured silicone elastomeric products made from cured silicone rubber compositions comprising kaolin based, silica-free fillers are sufficient but results are not as good as silica filled systems. However, the cost differential between silicas and kaolin is significant and as such for appropriate applications the use of kaolin can lead to dramatic cost reductions.

Therefore, the object of the present invention is to provide a silicone rubber composition that has excellent electrical properties, and while even lacking a silica reinforcing filler, excellent mechanical strengths. The present invention provides silicone rubber compositions that exhibit high mechanical strengths and excellent electrical properties, such as tracking resistance, arc resistance, and erosion resistance.

Silicone rubber compositions including HTV silicone rubber compositions can be, and often are, evaluated using various parameters including tensile strength which is the amount of force needed to break a rubber sample, elongation which is the length a rubber sample can be stretched, and compression set which is the amount of force needed for the permanent deformation of a rubber sample.

In accordance with a first embodiment of the present invention there is provided a silicone rubber composition comprising:

(i) an organopolysiloxane having a viscosity of at least 250,000 mPa·s at 25° C.

(ii) treated filler,

(iii) an organic peroxide curing agent;

which composition is substantially free of reinforcing silica fillers, characterised in that the filler comprises a mixture of aluminium trihydroxide and kaolin in a ratio of from 1:3 to 4:1.

Unless otherwise indicated all viscosity measurements are at 25° C. The composition in accordance with the invention can be utilised as a high consistency rubber (HCR) composition. When the composition in accordance with the present invention is an HCR, the viscosity of the organopolysiloxane polymer used is preferably at least 250 000 mPa·s at 25° C. but is typically greater than 1 000 000 mPa·s at 25° C., and has a Williams Plasticity number of at least 30.

As hereinbefore described the composition in accordance with the present invention composition is substantially free of reinforcing silica fillers. For the sake of this invention a reinforcing silica filler is intended to mean precipitated silica and fumed silica and any other reinforcing silica (and therefore excludes ground silica which is does not provide silicone rubber compositions with a reinforcing effect). It is to be understood that the term “substantially free” is intended to mean that the composition is essentially free of reinforcing silica fillers, such that silica fillers can only be present up to a maximum amount of 5 parts by weight per 100 parts by weight of the cumulative total weight of the polymer+treated aluminium trihydroxide and kaolin fillers. Alternatively, reinforcing silica fillers are present up to a maximum amount of 3 parts by weight per 100 parts by weight of the cumulative total weight of the polymer +treated aluminium trihydroxide and kaolin fillers. Alternatively, reinforcing silica fillers are present up to a maximum amount of 1 part by weight per 100 parts by weight of the cumulative total weight of the polymer+treated aluminium trihydroxide and kaolin fillers. In a further alternative the composition consists of aluminium trihydroxide and kaolin as the only reinforcing filler and contains zero reinforcing silica fillers. Alternatively aluminium trihydroxide and kaolin are the only fillers present in the composition. It is to be noted that a reinforcing effect is not generally noticed in the physical properties of a silicone rubber unless present in an amount of at least 25 parts by weight of reinforcing filler per 100 parts by weight of polymer. Hence at the levels permitted the reinforcing silica fillers present will have minimal or no reinforcing effect on the physical properties of the silicone rubber. As will be discussed in more detail below when present precipitated silica and/or fumed silica are used for their properties of rheology modifiers. Essentially the reinforcing effect which can be seen in compositions as described herein is provided by the reinforcing properties of aluminium trihydroxide and kaolin.

The organopolysiloxane polymer comprises one or more polymers which preferably have the formula:

RR¹₂SiO[(R₂Si-R⁵-(R₂)SiO)ₛ(R₂SiO)ₓ(RZSiO)_{y}]SiRR¹₂

wherein each R is the same or different and is an alkyl group containing 1-6 carbon atoms, a phenyl group or a 3,3,3-trifluoroalkyl group; each Z is the same or different and is hydrogen or an unsaturated hydrocarbon group such as an alkenyl group or an alkynyl group; each R¹ may be the same or different and needs to be compatible with the curing agent used such that the curing agent will cause the polymer to cure. R¹ may be selected from Z, R; a hydroxyl group and/or an alkoxy group. Each R⁵ may be the same or different and is a difunctional saturated hydrocarbon group having from 1 to 6 carbon atoms x is an integer and y is zero or an integer; s is zero or an integer between 1 and 50; and the sum of x+y+s is a number which results in a suitable polymer viscosity for the end product required. In the case of HCR compositions preferably the viscosity of the polymer is at least 500,000 mPa·s at 25° C. Alternatively In the case of HCR compositions the viscosity of the polymer is at least 1 000,000 mPa·s at 25° C. When y and/or s are integers the (R₂SiO) groups,(RZSiO) groups and/or (R₂Si-R⁵-(R₂)SiO) groups in the polymer chain are either randomly distributed or the organopolysiloxane polymer may be in the form of a block copolymer.

Preferably each R group is an alkyl group, most preferably each R is a methyl or ethyl group. Preferably when Z is an alkenyl group it has between 2 and 10 carbon atoms, more preferably between 2 and 7 carbon atoms, preferred examples being vinyl or hexenyl groups. R⁵ may be, for example, —CH₂—, —CH₂CH₂— and —CH₂CH₂CH₂— but most preferably each R⁵ is —CH₂CH₂—.

In one preferred embodiment of the present invention in which the composition is an HCR composition, the organopolysiloxane constituent of the composition may be a mixture of two or more organopolysiloxanes such as a two component mixture having the following formulae:

RR¹₂SiO[(R₂Si-R⁵-(R₂)SiO)ₛ(R₂SiO)ₓ(RZSiO)_{y}]Si RR¹₂ (1)

and

RR¹₂SiO[(R₂Si-R⁵-(R₂)SiO)ₛ¹(R₂SiO)ₓ¹(RZSiO)_{y}¹]SiRR¹₂ (2)

wherein each R is the same or different and is as described above and each R¹ is the same or different and is as described above; x, y and s are as previously defined and the value of x¹ y¹ and s¹ are in the same ranges as x, y and s respectively but at least one of x, y and s has a different value from the value of x¹ y¹ and s¹ respectively. Preferably at least 25% of R¹ groups are Z groups, most preferably alkenyl groups and a viscosity of the polymer mixture of at least 500,000 mPa·s at 25° C. alternatively at least 1 000,000 mPa·s at 25° C. with polymer (1) having a degree of polymerisation (DP) i.e. the value of x or the sum of x and y and/or s (when present) of at least 1,000 and polymer (2) having a DP i.e. the value of x¹ or the sum of x¹ and y¹ and/or s¹ (when present) of at least 100.

Hence, the composition may comprise a mixture of two high viscosity organopolysiloxane polymers with the formulae:

Me₂ViSiO[(Me₂SiO)ₓ(MeViSiO)_{y}]Si Me₂Vi

and

### Me₂ViSiO[(Me₂SiO)ₓ¹]Si Me₂Vi

wherein Me represents the methyl group (—CH₃) , Vi represents the vinyl group (CH₂=CH—), the value of the sum of x and y is at least 1,000 and the value of x¹ is at least 1000.

Alternatively in another preferred embodiment the organopolysiloxane comprises a mixture of a two components having the following formulae:

RR¹₂SiO[(R₂SiO)ₓ(RZSiO)_{y}(R₂Si-R⁵-(R₂)SiO)ₛ]SiRR¹₂

and

RR¹₂SiO[(R₂SiO)ₓ¹(RZSiO)_{y}¹]SiRR¹₂

wherein, in each formula, R Z and R¹ are as described above and x, y, s, x¹ and y¹ are as previously described and the viscosity of the mixture has a value of at least 500,000 mPa.s at 25° C. alternatively at least 1 000,000 mPa·s at 25° C. with the value of x or the sum of x and y and/or s (when either or both are present) being at least 1,000 and the value of x¹ and y¹ being between 100 and 1000. Preferably at least 25% of R¹s are Z groups, most preferably alkenyl groups and the value of x or the sum of x and y and/or s (when present) provides a viscosity of the polymer mixture of at least 500,000 mPa·s at 25° C., alternatively at least 1 000,000 mPa·s at 25° C. Typically the value of x or the sum of x and y and/or s (when present) is at least 1,000.

The inventors have surprisingly identified that the use of a combination of aluminium trihydroxide and kaolin as the filler provides a silicone rubber with more useful properties than for either filler alone. Such a silicone rubber can be used for high voltage electrical insulation Any suitable kaolin may be utilized, calcined kaolin is particularly preferred. Kaolin is well known in the art. It is an aluminium silicate which mainly comprises Al₂O₃.2SiO₂.2H₂O together with some illite and impurities. Kaolin is particularly useful because it is readily available in a white form. For the purposes of this invention “white” is to be regarded as the absence of a hue or tint of sufficient strength to prevent further pigmenting of the silicone elastomeric composition to a desired colour. Kaolin is further described in U.S. Pat. No. 4,677,141 incorporated by reference. Kaolin is added at 10 to 250 parts by weight and preferably at 25 to 200 weight parts, in each case per 100 weight parts of polymer.

Any suitable form of aluminum trihydroxide powder may be utilised as an ingredient in the composition of the present invention. Particle sizes in the range from 0.2 to 50 micrometers are generally employed, and particle sizes from 0.2 to 10 micrometers are preferably used. Aluminium trihydroxide is added at 10 to 250 parts by weight and preferably at 25 to 200 weight parts, in each case per 100 weight parts of polymer.

The ratio of aluminium trihydroxide to kaolin must be in a range of from 1:3 to 4:1. It has been found by the inventors that within this range there is a synergistic effect due to the mixing of these two fillers as typically a linear relationship would have been expected but unexpectedly does not occur within the range specified. Alternatively the ratio of aluminium trihydroxide to kaolin in compositions in accordance with the present invention is from 2:1 to 1:2.

As noted, it is an essential feature of the present invention to use a treated mixture of aluminium trihydroxide and kaolin filler, to render the filler(s) hydrophobic and therefore easier to handle and obtain a homogeneous mixture with the other components in the composition in accordance with the present invention. Hydrophobing the mixture of aluminium trihydroxide and kaolin results in the resulting hydrophobically modified mixture of aluminium trihydroxide and kaolin being easily wetted by the silicone polymer. Hydrophobically modified mixture of aluminium trihydroxide and kaolin does not clump, and therefore is easily homogeneously incorporated into the silicone polymer.

A treated mixture of aluminium trihydroxide and kaolin fillers comprises the majority of filler present in the composition and is present in an amount of from about 50 to 300 parts by weight per 100 parts by weight of polymer, more preferably 30-150 parts by weight per 100 parts by weight of the polymer and most preferably from 50 to 125 parts by weight per 100 parts by weight of the polymer.

Any suitable treating agent which renders the surface of the mixture of aluminium trihydroxide and kaolin hydrophobic may be used. Examples include organic treating agents such as fatty acids and/or fatty acid esters e.g. a stearate, or organosilanes, organosilazanes such as hexaalkyl disilazane or short chain organopolysiloxane polymers e.g. short chain siloxane diols.

Silanes found to be most suitable for the treatment of mixture of aluminium trihydroxide and kaolin are alkoxysilanes of the general formula R³(₄₋ₙ)Si(OR³)ₙ, wherein n has a value of 1-3; and each R³ is the same or different and represents a monovalent organic radical such as an alkyl group, an aryl group, or a functional group such as an alkenyl group, e.g. vinyl or allyl, an amino group or an amino group. Some suitable silanes therefore include alkyltrialkoxysilanes such as methyltriethoxysilane, methyltrimethoxysilane, phenyl tialkoxysilanes such as phenyltrimethoxysilane, or alkenyltrialkoxysilanes such as vinyltriethoxysilane, and vinyltrimethoxysilane. If desired, silazanes can also be used as treating agents for the mixture of aluminium trihydroxide and kaolin filler. These include (but are not restricted to) hexamethyldisilazane; 1,1,3,3-tetramethyldisilazane; and 1,3-divinyltetramethyldisilazane. Other suitable treating agents which may be utilised in the present invention include those described in the applicant's co-pending patent application WO2008034806.

Short chain organopolysiloxanes might for example include hydroxy terminated polydimethylsiloxanes having a degree of polymerisation of from 2 to 20, hydroxy terminated polydialkyl alkylalkenylsiloxanes having a degree of polymerisation of from 2 to 20 and organopolysiloxanes comprising at least one Si-H group, which may or may not be a terminal group, e.g. those having the formula:

R⁴ₕH₃₋ₕSiO[(R⁴₂SiO)_{f}(R⁴HSiO)_{g}]SiR⁴ₕH₃₋ₕ

wherein in each formula, R⁴ represents an alkyl group containing 1-6 carbon atoms; H is hydrogen, h is zero or an integer from 1 to 3, f and g are independently zero or an integer with the proviso that the treating agent has at least one Si—H group and a viscosity of from 5 to 5000 mPa·s at 25° C.

Preferably when treated approximately 1 to 10% by weight of the treated mixture of aluminium trihydroxide and kaolin filler will be treating agent. Alternatively the treating agent will be from 2.5 to 10% weight of the treated mixture of aluminium trihydroxide and kaolin filler. The filler may be pre-treated before addition into the composition or may be treated in situ during mixing with the polymer.

A curing agent, as noted above, is required and compounds which can be used herein include organic peroxides such as dialkyl peroxides, diphenyl peroxides, benzoyl peroxide, 1,4-dichlorobenzoyl peroxide, paramethyl benzoyl peroxide, 2,4-dichlorobenzoyl peroxide, di-t-butyl peroxide, dicumyl peroxide, tertiary butyl-perbenzoate, monochlorobenzoyl peroxide, ditertiary-butyl peroxide, 2,5-bis-(tertiarybutyl-peroxy)-2,5-dimethylhexane, 1,1-bis(t-butylperoxy)-3,3,5-trimethylcyclohexane tertiary-butyl-trimethyl peroxide, tertiary-butyl-tertiary-butyl-tertiary-triphenyl peroxide, and t-butyl perbenzoate. The most suitable peroxide based curing agents are benzoyl peroxide, 2,4-dichlorobenzoyl peroxide, di-t-butyl peroxide, and dicumyl peroxide. Organic peroxides such as the above are particularly utilised when R¹ in the polymer as defined above is an alkyl group but the presence of some unsaturated hydrocarbon groups per molecule is preferred. It may also be used as the curing agent when R¹ is Z as hereinbefore described.

These organic peroxides may be formed into a paste by dispersing in a silicone oil for ease of introduction into the composition. It is recommended that they are be used in an amount of 0.1 to 10 parts by weight, preferably 0.5 to 2.0 parts by weight, per 100 parts by weight of polymer.

As previously discussed, the filler comprises a mixture of aluminium trihydroxide and kaolin in a ratio of from 1:3 to 4:1. It has been identified that when aluminium trihydroxide is absent from the composition in some instances the composition will not cure. This is particularly the situation seen when using 2,5-bis-(t-butyl peroxy)-2,5-dimethylhexane (DHBP) as the peroxide catalyst. It is thought that this may be due to the kaolin being sensitive to acid degradation. Furthermore when there is only aluminium trihydroxide present in the composition unwanted foaming can occur during the cure in the presence of some peroxide catalysts, in particular 2,4-dichlorobenzoyl peroxide.

As hereinbefore described the composition of the present invention is preferably free of reinforcing silica fillers. However the composition may comprise up to 5 parts per weight per 100 parts by weight of polymer+treated mixture of aluminium trihydroxide and kaolin of a rheology modifier. Preferably when present the rheology modifier is present in an amount of from 1 to 3 parts by weight per 100 parts by weight of polymer +treated mixture of aluminium trihydroxide and kaolin. The rheology modifier may comprise polytetrafluoroethylene (PTFE), boric acid, amorphous precipitated or fumed silica. It is to be understood that the amount of silica present within the ranges permitted are such that it is present in such low amounts so as to have a negligible effect on the physical properties of the resulting composition.

Whilst the composition may also be free of all other fillers, the composition may comprise additional fillers (other than silica reinforcing fillers) such as finely divided, calcium carbonate or additional non-reinforcing fillers such as crushed quartz, diatomaceous earths, barium sulphate, iron oxide, titanium dioxide and carbon black, talc, wollastonite. Other fillers which might be used alone or in addition to the above include aluminite, calcium sulphate (anhydrite), gypsum, calcium sulphate, magnesium carbonate, clays such as magnesium hydroxide (brucite), graphite, copper carbonate, e.g. malachite, nickel carbonate, e.g. zarachite, barium carbonate, e.g. witherite and/or strontium carbonate e.g. strontianite, halloysite, sepiolite and/or attapulgite.

Silicates from the group consisting of olivine group; garnet group; aluminosilicates; ring silicates; chain silicates; and sheet silicates. The olivine group comprises silicate minerals, such as but not limited to, forsterite and Mg₂SiO₄. The garnet group comprises ground silicate minerals, such as but not limited to, pyrope; Mg₃Al₂Si₃O₁₂; grossular; and Ca₂Al₂Si₃O₁₂. Aluninosilicates comprise ground silicate minerals, such as but not limited to, sillimanite; Al₂SiO₅; mullite; 3Al₂O₃.2SiO₂; kyanite; and Al₂SiO₅. The ring silicates group comprises silicate minerals, such as but not limited to, cordierite and Al₃(Mg,Fe)₂[Si₄AlO₁₈]. The chain silicates group comprises ground silicate minerals, such as but not limited to, wollastonite and Ca[SiO₃].

The sheet silicates group comprises silicate minerals, such as but not limited to, mica; K₂AI₁₄[Si₆Al₂O₂₀](OH)₄; pyrophyllite; Al₄[Si₈O₂₀](OH)₄; talc; Mg₆[Si₈O₂₀](OH₄; serpentine for example, asbestos; and vermiculite.

The above fillers may be used untreated but are preferably treated with one of the hydrophobing treating agents described above in any suitable manner.

Other ingredients which may be included in the compositions include but are not restricted to ; rheological modifiers; Adhesion promoters, pigments, colouring agents, desiccants, heat stabilizers, Flame retardants, UV stabilizers, cure modifiers, electrically and/or heat conductive fillers, blowing agents, anti-adhesive agents, handling agents, peroxide cure co-agents such as metal salts of carboxylic acids and amines and acid acceptors. It will be appreciated that some of the additives are included in more than one list of additives. Such additives would then have the ability to function in all the different ways referred to.

Any suitable adhesion promoter(s) may be incorporated in a rubber composition in accordance with the present invention. These may include for example alkoxy silanes such as aminoalkylalkoxy silanes, epoxyalkylalkoxy silanes, for example, 3-glycidoxypropyltrimethoxysilane and, mercapto-alkylalkoxy silanes and γ-aminopropyl triethoxysilane, reaction products of ethylenediamine with silylacrylates. Isocyanurates containing silicon groups such as 1,3,5-tris(trialkoxysilylalkyl) isocyanurates may additionally be used. Further suitable adhesion promoters are reaction products of epoxyalkylalkoxy silanes such as 3-glycidoxypropyltrimethoxysilane with amino-substituted alkoxysilanes such as 3-aminopropyltrimethoxysilane and optionally alkylalkoxy silanes such as methyl-trimethoxysilane. epoxyalkylalkoxy silane, mercaptoalkylalkoxy silane, and derivatives thereof.

Heat stabilizers may include Iron oxides and carbon blacks, Iron carboxylate salts, cerium hydrate, barium zirconate, magnesium oxide, cerium and zirconium octoates, and porphyrins.

Flame retardants may include for example, carbon black, hydrated aluminium hydroxide, and silicates such as wollastonite, platinum and platinum compounds.

Electrically conductive fillers may include carbon black, metal particles such as silver particles any suitable, electrically conductive metal oxide fillers such as titanium oxide powder whose surface has been treated with tin and/or antimony, potassium titanate powder whose surface has been treated with tin and/or antimony, tin oxide whose surface has been treated with antimony, and zinc oxide whose surface has been treated with aluminium.

Thermally conductive fillers may include metal particles such as powders, flakes and colloidal silver, copper, nickel, platinum, gold aluminium and titanium, metal oxides, particularly aluminium oxide (Al₂O₃) and beryllium oxide (BeO);magnesium oxide, zinc oxide, zirconium oxide; Ceramic fillers such as tungsten monocarbide, silicon carbide and aluminium nitride, boron nitride and diamond.

Handling agents are used to modify the uncured properties of the silicone rubber such as green strength or processability sold under a variety of trade names such as SILASTIC® HA-1, HA-2 and HA-3 sold by Dow Corning corporation).

Peroxide cure co-agents are used to modify the properties, such as tensile strength, elongation, hardness, compression set, rebound, adhesion and dynamic flex, of the cured rubber. These may include di- or tri-functional acrylates such as Trimethylolpropane Triacrylate and Ethylene Glycol Dimethacrylate; Triallyl Isocyanurate, Triallyl Cyanurate, Polybutadiene oligomers and the like. Silyl-hydride functional siloxanes may also be used as co-agents to modify the peroxide catalysed cure of siloxane rubbers.

The acid acceptors may include Magnesium oxide, calcium carbonate, Zinc oxide and the like.

The ceramifying agents can also be called ash stabilisers and include silicates such as wollastonite.

Silicone rubber compositions having acceptable mechanical properties when compared to conventional silicone rubber compositions can be produced according to the present invention in a process which involves no heat, and which avoids the necessity to use expensive fumed silica as a reinforcing filler.

Compositions in accordance with the present invention may be prepared in accordance with any suitable method. The conventional route of preparing highly filled silicone rubber compositions is to first make a silicone rubber base by heating a mixture of reinforcing filler (typically e.g. fumed silica), a treating agent for the reinforcing filler (fumed silica), and an organopolysiloxane e.g. a polysiloxane gum in a mixer. The silicone rubber base is removed from the first mixer and transferred to a second mixer where generally about 150 parts by weight of a non-reinforcing or extending filler such as ground quartz is added per 100 parts by weight of the silicone rubber base. Other additives are typically fed to the second mixer such as curing agents, pigments and colouring agents, heat stabilizers, anti-adhesive agents, plasticisers, and adhesion promoters. This route may also be utilised for compositions of the present invention with the reinforcing filler being a mixture of aluminium trihydroxide and kaolin.

It is to be understood that room temperature conditions means atmospheric pressure and a room temperature at normal ambient temperature of 20-25° C. It is a major advantage in the case of the present invention that heat is not required to be added during step (i) as is required when undertaking the in-situ treatment of reinforcing fillers. As in all mixing processes the effect of mixing will generate heat but mixing in the case of the present invention will not require any additional heat input.

Because kaolin/aluminium trihydroxide disperses much more easily than fumed silica in polysiloxane gums, the total mixing cycle is considerably reduced, giving much greater mixer utilization. In addition, since kaolin/aluminium trihydroxide is a semi-reinforcing filler, it is capable of providing a finished composition having adequate mechanical properties. However, because the combination of kaolin/aluminium trihydroxide is only semi-reinforcing, a higher loading level needs to be used than would be the case for fumed silica. On the other hand, because of the lower cost of kaolin/aluminium trihydroxide compared to silica, it is not necessary to use a large amount of mixture of aluminium trihydroxide and kaolin to obtain the right level of economic attractiveness for the finished composition. Preferably the weight ratio of treated kaolin/aluminium trihydroxide to organopolysiloxane is from 1:2 to 2:1.

The same level of mechanical properties can thereby be obtained as with finished compositions containing fumed silica. Furthermore, the elimination of fumed silica means that no heating is required, and the whole compounding process can be carried out in a single mixer. In addition, the incorporation time for kaolin/aluminium trihydroxide is much faster than for fumed silica, with the result that mixer capacity is increased by utilizing the faster throughput. Finally kaolin/aluminium trihydroxide has a much higher bulk density than fumed silica, which allows much improved ease of handling and storage.

These finished mixture of aluminium trihydroxide and kaolin containing silicone rubber compositions are useful in applications such as silicone profile extrusions, wire and cable coatings, glazing, and for construction gaskets. Specific examples include the use of this product in window glazing gaskets, wire and cable such as plenum or safety cable sheathing applications, double glazing spacer gaskets. The only requirement relative to its use is that the finished composition has a property profile roughly equivalent to that acceptable for the particular application. The composition of the present invention may also be used in the production of silicone rubber sponges with the addition of a suitable foaming agent. Any suitable foaming agent may be used. The resulting product is particularly useful for manufacturing insulating glazing spacer gaskets. Surprisingly, the invention has good volume resistivity, dielectric constant, dissipation factor, tracking resistance, arc resistance, and erosion resistance.

The following examples are set provided in order to illustrate the invention in more detail.

As used herein, the term room temperature is intended to mean the normal ambient temperature of from 20-25° C. All viscosities were measured at 25° C. unless otherwise indicated.

### EXAMPLES

Untreated Kaolin and untreated aluminium trihydroxide may be bought pre-treated with an hydrophobing agent, may be mixed in a specific predetermined ratio and treated or can be treated in situ wherein the treating agent filler and polymer are all mixed together.

### LABORATORY PREPARATION OF A TREATED KAOLIN AND TREATED ALUMINIUM TRIHYDROXIDE MIXTURE

The filler mixture in accordance with the present invention may be treated prior to introduction into the polymer(s). For example the following process may be used for such a purpose. A predetermined mixture ratio of untreated Kaolin and untreated aluminium trihydroxide was placed in the mixing bowl of an ordinary domestic food mixer. The chosen treating agent was then introduced into the mixing bowl in a sufficient quantity to obtain the desired level of treatment of the Kaolin and aluminium trihydroxide surface. The mixer was left to run for 10 min minutes, scraping down any residual material attached to the blade and side wall of the bowl. The sample was mixed for a further 15 minutes and then the contents of the mixing bowl were then transferred to a metal tray, and placed in an air circulating oven at 120° C. for a minimum period of 12 hours.

Compositions in accordance with the present invention were however prepared by purchasing pre-treated fillers and mixing them together prior to introduction into the polymer. The kaolin utilised was a calcined kaolin obtained from Imerys under the product name NPD 22B. It was believed to have been treated with methyltrimethoxysilane. The aluminium trihydroxide utilised was from Huber, Huber® M9400SP and was treated with a proprietary silane based treating agent. The respective treated fillers were therefore merely weighed and mixed in predetermined proportions.

### COMPOUNDING-PROCEDURE

A silicone rubber base, comprising a mixture of two organopolysiloxane polymers and filler was first prepared. The total amount of filler used was either 50% by weight of the base or 57.5% by weight of the base with the proportion of treated Kaolin (Imerys® NPD 22B) and treated aluminium trihydroxide (Huber® M9400SP) being varied as indicated in Table 1A.

TABLE 1A

| | Total Filler | ATH (% by | Kaolin (% by |
|---|---|---|---|
| | Content (% by | weight of | weight of filler |
| Sample | weight of base | filler mixture) | mixture) |
| 1 (comparative) | 57.5 | 100 | 0 |
| 2 | 57.5 | 80 | 20 |
| 3 | 57.5 | 50 | 50 |
| 4 | 57.5 | 20 | 80 |
| 5 (Comparative) | | 0 | 100 |
| 6 (Comparative) | 50 | 100 | 0 |
| 7 | 50 | 80 | 20 |
| 8 | 50 | 50 | 50 |
| 9 | 50 | 20 | 80 |
| 10 (Comparative) | | 0 | 100 |

The remainder of the base was made of equal parts of

a) a dimethylvinylsiloxy terminated dimethylsiloxane-methylvinylsiloxane copolymer, in which the mole ratio of dimethylsiloxane units to methylvinylsiloxane units was 99.82:0.18, with an average dp of 7,000; and

b) a dimethylvinylsiloxy terminated polydimethylsiloxane with an average dp of 7,000, having both of its terminal ends of the molecular chain endblocked by dimethylvinylsiloxy groups.

hence when the proportion of filler in the base is 57.5% by weight (a) and (b) are used in equal amounts of 21.25% by weight of the base and when the proportion of filler in the base is 50% by weight (a) and (b) are used in equal amounts of 25% by weight of the base.

Initially (a) and (b) were mixed together in the appropriate amounts and then the respective amounts of each filler was introduced into the (a) and (b) mixture in a Brabender internal mixer. In every case, the mixing procedure used was the same. According to the procedure, the mixer blades were initiated so as to rotate at maximum speed, the required quantity of PDMS was placed in the mixer, the required quantity of treated filler was added to the mixer, and once the filler mixture addition had been completed, the mixer was allowed to run for an additional 30 minutes. The fill level of the mixer was kept constant by calculating the amount of filler mixture and PDMS in volumetric terms.

### TESTING OF THE COMPOUNDS

The resulting bases were mixed with a suitable curing agent on a two-roll mill. The curing agent used in all the experiments was 2,5-bis-(t-butyl peroxy)-2,5-dimethylhexane (DHBP) in an amount of 1 part by weight based per 100 parts by weight of polymer ((a) + (b)). The curing agent was introduced in the form of a paste in polymer (b).

A variety of tests were utilised to assess the suitability of silicone rubber materials in accordance with the present invention. The Williams plasticity number (Plasticity) was measured using a Wallace Plastometer in accordance with ASTM D926 (as discussed above).

Samples used for the physical properties results were obtained from a press molded sheet which had been prepared by press molding for 10 min at 170° C. under a pressure of 2 MPa to form a silicone rubber sheet with a thickness of 2 mm. Specimens were cut from the resultant sheet and mechanical properties were measured. Shore A Durometer measurements (ShA) were determined by ASTM D2240. Tensile Strength (Tensile) 100% Modulus (100% Mod) and Elongation (ETB) where determined by DIN 53 504.

TABLE 1B
Physical properties of elastomers prepared as described above

| | Plasticity | | Tensile | 100% Mod |
|---|---|---|---|---|
| Sample | (mm) | ShA | (MPa) | (MPa) |
| 1 | 196 | 58 | 5.3 | 2.4 |
| 2 | 209 | 60 | 5.8 | 2.8 |
| 3 | 222.5 | 64 | 6.1 | 3.2 |
| 4 | 289.5 | 62 | 4.6 | 2.6 |
| 5 (comp) | DNC | DNC | DNC | DNC |
| 6 (comp) | 190 | 46 | 5.1 | 1.4 |
| 7 | 189 | 49 | 5.3 | 1.4 |
| 8 | 191.5 | 50 | 5.6 | 2 |
| 9 | 196 | 46 | 4.8 | 1.9 |
| 10 (comp) | DNC | DNC | DNC | DNC |

It can be seen that when using only kaolin (i.e. 5(comp) and 10 (comp)) as described above the elastomeric product of the composition failed to cure. The inventors expected to identify a linear relationship in results when compared to the amounts of each filler present in the composition. However, surprisingly this did not occur and in the range selected in the present application a positive synergistic effect is observed with properties such as Shore A hardness, tensile strength and 100% modulus, particularly in the cases of examples 3 and 8.

### Example 2

The same pre-treated fillers were used as described in example 1. The compounding procedure was as the same as described in for example 1 with the exception that only one organopolysiloxane polymer, a dimethylvinylsiloxy terminated polydimethylsiloxane with an average dp of 7,000, having both of its terminal ends of the molecular chain endblocked by dimethylvinylsiloxy groups used. The total amount of filler was 60% by weight of the total base (polymer+filler) with the proportion of treated Kaolin (Imerys® NPD 22B) and treated aluminium trihydroxide (Huber® M9400SP) being varied as indicated in Table 2A. The compositions in example 2 were mixed as described in example 1 with the exception except that 1.2 parts of a paste of 50% 2,4-dichlorobenzoyl peroxide in polydimethylsiloxane per 100 parts by weight of base were prepared.

TABLE 2A

| | Total Filler | ATH (% by | Kaolin ((% by |
|---|---|---|---|
| | Content (% by | weight of | weight of filler |
| Sample | weight of base | filler mixture) | mixture)%) |
| 1 (comparative) | 60 | 100 | 0 |
| 2 | 60 | 50 | 50 |
| 3 (comparative) | 60 | 0 | 100 |

Test sheets were prepared by press molding at 116° C. for 5 minutes followed by post-curing at 200° C. for 4 hours and samples from the sheets were tested as described in Example 1 and depicted in Table 2B below.

TABLE 2B
Physical properties of elastomers prepared as described above

| | Plasticity | | Tensile | | 100% Mod |
|---|---|---|---|---|---|
| Sample | (mm) | ShA | (MPa) | EB % | (MPa) |
| 1 | 428 | 66 | 5.0 | 143 | 3.7 |
| 2 | 275 | 51 | 4.8 | 167 | 3.0 |
| 3 | 218 | 60, Foamed | 4.9 | 222 | 2.3 |
| | | on Post Cure | | | |

Heat aging was carried out by suspending pre-cut test specimens in ovens at the desired temperatures for the desired times as indicated in Table 2C. Samples were then removed allowed to cool and equilibrate overnight prior to testing as above.

TABLE 2C

| | 10 days @ 200° C. | | | 60 days @ 210° C. | |
|---|---|---|---|---|---|
| | | Tensile | | Tensile | |
| Sample | ShA | (MPa) | EB (%) | (MPa) | EB (%) |
| 1 | 88 | 6.1 | 57 | Brittle | Brittle |
| 2 | 58 | 3.8 | 144 | 4.2 | 64 |
| 3 | Foamed | 3.8 | 296 | 3.4 | 160 |

From the results it can be seen that whilst sample 1 gives good initial properties the use of an all Kaolin filler composition tends to give a material that becomes brittle on heat aging. The 100% aluminium trihydroxide (ATH) filled composition (sample 3) gave a poor initial material that foamed, particularly during post cure and whilst its physical properties remained reasonable on heat aging the foaming observed prevents its use in many applications. Sample 2 which is in accordance with the present invention gave the best balance with reasonable initial properties coupled with good heat aging performance. In the case of sample 2 no tendency to foam was noticed and heating aging results made the composition acceptable for use.

1. A silicone rubber composition comprising:
(i) an organopolysiloxane having a viscosity of at least 250,000 mPa·s at 25° C.
(ii) treated filler,
(iii) a curing agent;
which composition is substantially free of reinforcing silica fillers, characterised in that the treated filler comprises a mixture of aluminium trihydroxide and kaolin in a ratio of from 1:3 to 4:1.

2. A composition according to claim 1 in which the organopolysiloxane comprises one or more polymers which have the formula :
RR¹₂SiO[(R₂Si-R⁵-(R₂)SiO)ₛ(R₂SiO)ₓ(RZSiO)_{y}]SiRR¹₂
wherein each R is the same or different and is an alkyl group containing 1-6 carbon atoms, a phenyl group or a 3,3,3-trifluoroalkyl group; each Z is the same or different and is hydrogen or an unsaturated hydrocarbon group; each R¹ may be the same or different and is compatible with the curing agent such that the curing agent will cause the polymer to cure, and R¹ is selected from Z, R; a hydroxyl group and/or an alkoxy group; each R⁵ may be the same or different and is a difunctional saturated hydrocarbon group having from 1 to 6 carbon atoms; x is an integer, y is zero or an integer; s is zero or an integer between 1 and 50.

3. A composition according to claim 1 in which the organopolysiloxane is a two component mixture comprising a mixture of two high viscosity organopolysiloxane polymers with the formulae:
Me₂ViSiO[(Me₂SiO)ₓ(MeViSiO)_{y}]Si Me₂Vi
and
Me₂ViSiO[(Me₂SiO)ₓ¹]Si Me₂Vi
wherein Me represents the methyl group (—CH₃), Vi represents the vinyl group (CH₂=CH—), the value of the sum of x and y is at least 1,000 and the value of x¹ is at least 1000.

4. A composition according to claim 1 in which the organopolysiloxane is a two component mixture having the following formulae:
RR¹₂SiO[(R₂SiO)ₓ(RZSiO)_{y}(R₂Si-R⁵-(R₂)SiO)ₛ]SiRR¹₂
and
RR¹₂SiO[(R₂SiO)ₓ¹(RZSiO)_{y}¹]SiRR¹₂
wherein, in each formula, wherein each R is the same or different and is an alkyl group containing 1-6 carbon atoms, a phenyl group or a 3,3,3-trifluoroalkyl group; each Z is the same or different and is hydrogen or an unsaturated hydrocarbon group; each R¹ may be the same or different and is compatible with the curing agent such that the curing agent will cause the polymer to cure, and R¹ is selected from Z, R; a hydroxyl group and/or an alkoxy group; x is an integer, y is zero or an integer; s is zero or an integer between 1 and 5; x¹ and y¹ are in the same ranges as x and y; and the viscosity of the mixture has a value of at least 500,000 mPa·s at 25° C. with the value of x or the sum of x and y and/or s (when either or both are present) being at least 1,000 and the value of x¹ and y¹ being between 100 and 1000.

5. A composition according to claim 1 characterised in that the mixture of aluminium trihydroxide and kaolin is treated with an organopolysiloxane selected from the group of hydroxy terminated polydimethylsiloxanes having a degree of polymerisation of from 2 to 20, hydroxy terminated polydialkyl alkylalkenylsiloxanes having a degree of polymerisation of from 2 to 20 and a treating agent having the formula:
R⁴ₕH₃₋ₕSiO[(R⁴₂SiO)_{f}(R⁴HSiO)_{g}]SiR⁴ₕH₃₋ₕ
wherein in each formula, R⁴ represents an alkyl group containing 1-6 carbon atoms; H is hydrogen, h is zero or an integer from 1 to 3; and f and g are independently is zero or an integer which treating agent has at least one Si—H groups and a viscosity of from 5 to 500 mPa·s at 25° C.

6. A composition according to claim 1 wherein the mixture of aluminium trihydroxide and kaolin comprises a mixture of aluminium trihydroxide and kaolin treated with an alkoxysilane of the formula:
R³₍₄₋ₙ₎Si(OR³)ₙ
wherein n has a value of 1-3; and R³ is an alkyl group, an aryl group, or an alkenyl group.

7. A composition according to claim 6 in which the alkoxysilane is a compound selected from the group consisting of methyltriethoxysilane, methyltrimethoxysilane, phenyltrimethoxysilane, vinyltriethoxysilane, and vinyltrimethoxysilane.

8. A composition according to claim 1 wherein the ratio of aluminium trihydroxide to kaolin is from 1:2 to 2:1.

9. A composition according to claim 1 in which the curing agent is a peroxide selected from the group consisting of benzoyl peroxide, 2,5-bis-(t-butyl peroxy)-2,5-dimethylhexane, 2,4-dichlorobenzoyl peroxide, di-t-butyl peroxide, and dicumyl peroxide.

10. A composition in accordance with claim 1 in which the curing agent is an organohydrogensiloxane curing agent, and a platinum group metal hydrosilylation catalyst is added in an amount sufficient to cure the composition.

11. A method of making a treated mixture of aluminium trihydroxide and kaolin containing silicone rubber composition in accordance with claim 1, which method consists essentially of the steps:
(i) mixing an organopolysiloxane and a treated mixture of aluminium trihydroxide and kaolin under room temperature conditions, and
(ii) adding a curing agent to the mixture in (i); and curing the mixture in (ii) at a temperature above room temperature by the application of heat.

12. A method according to claim 11 in which room temperature is normal ambient temperature of 20-25° C.

13. (canceled)

14. A composition according to claim 1 characterised in that the silicone rubber composition is free of silica.

15. A composition according to claim 1 wherein the treated mixture of aluminium trihydroxide and kaolin is the sole reinforcing filler in the silicone rubber composition.

16. An article comprising a silicone rubber composition in accordance with claim 1, wherein the article is selected from the group consisting of silicone profile extrusions, wire and cable coatings, glazing gaskets, high voltage insulations, and construction gaskets.

17. A silicone rubber composition comprising:
(i) an organopolysiloxane having a viscosity of at least 250,000 mPa·s at 25° C.
(ii) treated filler and
(iii) an organic peroxide curing agent;
characterised in that the treated filler consists of a mixture of aluminium trihydroxide and kaolin in a ratio of from 1:3 to 4:1.
